(19) United States
(12) Patent Application Publication
(10) Pub. No.: US 2005/0260319 A1
(43) Pub. Date: Nov. 24, 2005

(54) Manufacture of baked dough products

(76) Inventor: Richard Anthony Khalaf, Beirut (LB)

Correspondence Address: Breiner & Breiner, L.L.C., P.O. Box 19290, Alexandria, VA, 22320-0290, US

(21) Appl. No.: 11/134,345

(22) Filed: May 23, 2005

(30) Foreign Application Priority Data
May 22, 2004 (GB) 0411480.7

(51) Int. Cl. A21D 2/00

(52) U.S. Cl. 426/549

(57) ABSTRACT

Traditional unleavened dough breads are made by hand and in circular form. This is inefficient and the product is uneven in taste and texture, which is unsatisfactory and leads to wastage. It is also difficult to pack. In accordance with the invention, a continuous process of making baked unleavened dough products is described where an extruded strip of dough is passed through a heated oven section and the cooked dough strip then sized and cut into rectangular breads. The process is of particular value to mechanize the production of Saj bread, producing a product of a more even quality and more consumer-acceptable shape.

### FIELD OF THE INVENTION

This invention relates to the manufacture of baked dough products and in particular to the manufacture of baked breads of a type widely consumed in the Middle East. Although it represents only one of many local varieties, the term “Saj bread” will be used herein to describe generally a single layer baked dough product, normally baked from a dough containing only a little yeast or like leavening agent.

### BACKGROUND TO THE INVENTION

The traditional hand-made method of manufacture of such saj breads involves taking a quantity of mixed dough and forming it into a generally circular shape. This may be as much as 60 centimetres in diameter. Such a flat generally circular shape is conventionally made by spinning the dough, but this has the major disadvantage that the thickness of the so spun dough circular shape is not uniform. This can result, following cooking of the dough on an open flame grill or the like, in the middle of the circle of baked dough being thin, dry and hard, while the outside is too thick, doughy and undercooked. The energy requirements for such cooking are substantial and energy use is inefficient. Additionally, spinning must be done by hand, which is both labour-intensive and unhygienic.

We have now found that Saj bread may be made in a considerably more consistent and convenient fashion by forming the dough in a fashion different from the traditional centrifugal spinning.

### GENERAL DESCRIPTION OF THE INVENTION

According to a first feature of the present invention, there is provided a method of making a baked dough product which includes the steps of forming a quantity of dough, extruding the dough to form a thin ribbon, passing the ribbon through a heated chamber to cook it, and severing the ribbon into successive rectangular pieces.

The method of this invention is of particular value in the manufacture of Saj bread since it not only provides a mechanical and continuous process of making the bread, but the texture of the bread is materially improved, both as to the evenness of the texture and, in particular, the avoidance of portions which are either too thick and doughy, or too thin and fragile or burnt.

Also important is that the Saj bread so produced is produced in rectangular form, thus enabling considerably greater efficiency in terms of packaging. Conventionally, hand-made round Saj breads are folded into a rectangular shape and then placed in a rectangular loose plastics casing.

Finally, because of the evenness of texture, essentially the entire bread is edible and, for example, there is no waste because of the need to throw away inedible doughy edge portions.

The particular design of apparatus for putting the present invention into practice may vary widely, but conveniently and preferably consists of an elongated heating chamber having conveyor means arranged therein for passing the strip of dough through the chamber. The passage is conveniently sinuous in order to keep the size of the apparatus within sensible limits, and the arrangement may be such as to provide an optimised thermal profile as the strip of dough which is gradually baked passes through the chamber. Generally, the initial cooking is at high temperature followed by a longer lower temperature phase. In order to feed the strip of dough into the chamber, a conventional hopper and extruder means may be provided, the extrusion nozzle being in the form of an elongate slit, for example 30 cm long and 2 mm wide. If desired, a very wide strip may be produced and slit longitudinally after cooling to the desired width, or if the heating chamber is wide, a plurality of separately extruded dough strips may be laid down side-by-side and passed through it.

The heating/cooling chamber may be followed, in apparatus for carrying out the present invention, by a cooling chamber through which the baked dough strip is passed, enabling control both of the cooling time/temperature profile and of the cooling down phase, in order to provide optimum results.

Because of the physical and partly elastic properties of unbaked dough, there is a tendency, if dough is extruded in flat ribbon form, for the ribbon to shrink. This may be counteracted by providing, between the extrusion of slot and the entry into the heating chamber, one or more pairs of rollers adapted to engage on opposite sides of the strip of dough and essentially to calender it. In a highly preferred approach, such calendering and sizing is carried out by passing the strip through two pairs of rollers each mounted to one side of the strip and where the axes of the rollers do not run perpendicular to the direction of elongation of the strip/direction of movement of the strip, but rather are inclined thereto and, seen at the position of the rollers, pointing downstream. On passing through such sets of inclined rollers, the outer edges of the strip of dough are biased slightly outwards, thus assisting relieving the internal tensions in the dough and the tendency for the flat strip to contract laterally.

The uncooked dough is sufficiently flexible to enable transportation by rollers or on conveyor belts, and even when the dough has just been cooked, it maintains a sufficient flexibility to enable it to be handled as a continuous ribbon. As it exits the heating chamber, however, following the cooking process, it tends to harden up and become less flexible so it is preferred that, immediately downstream of the cooling chamber, there is located an appropriate station at which the strip is chopped into rectangles and the rectangles then stacked and preferably immediately packed.

Other conventional features of continuous food manufacturing or processing machinery may be used as desired, for example UV irradiation to ensure sterility, and blowing air at the strip of product to cool it more rapidly. It should be noted that Saj bread is thin enough to enable UV sterilisation to be effective throughout the bread, not just on the external surface thereof.

### PREFERRED EMBODIMENTS OF THE INVENTION

While the method of the present invention is generally applicable to manufacturing baked dough products, it is, as noted above, of particular value in the manufacture of Saj bread. A typical recipe for the dough for making Saj bread is as follows:

| | |
|---|---|
| wheat flour | 1 kg |
| water | 0.4 kg |
| salt | 1 gram |
| yeast | 2 grams |
| Sugar | 1 gram |

flavour (e.g. onion, cinnamon) (optional)

These are mixed together and the mixture allowed to prove, e.g., for 30 minutes at ambient temperature. Thereafter, the mixture may be extruded and baked as described above.

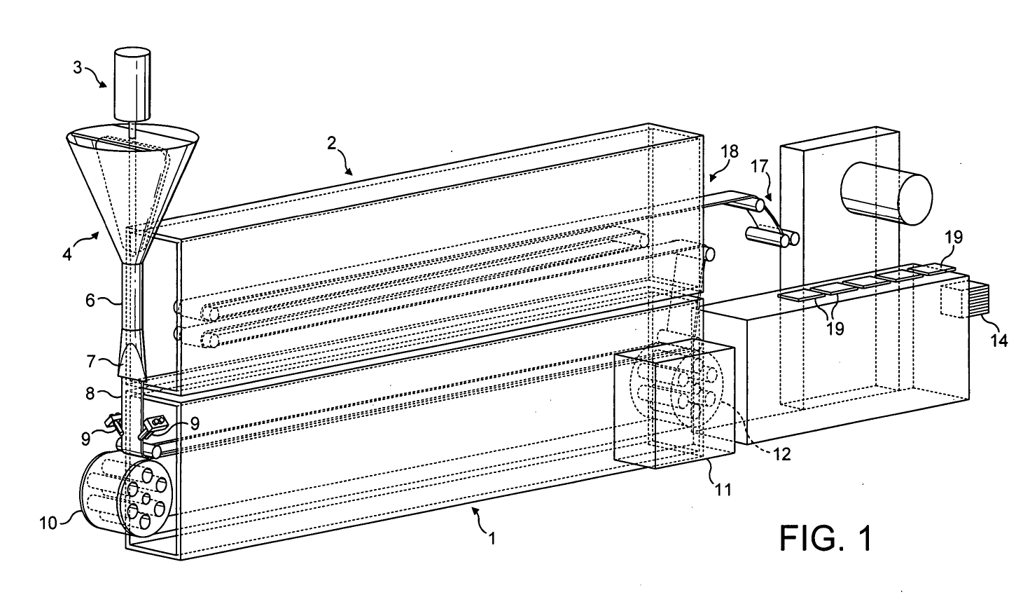

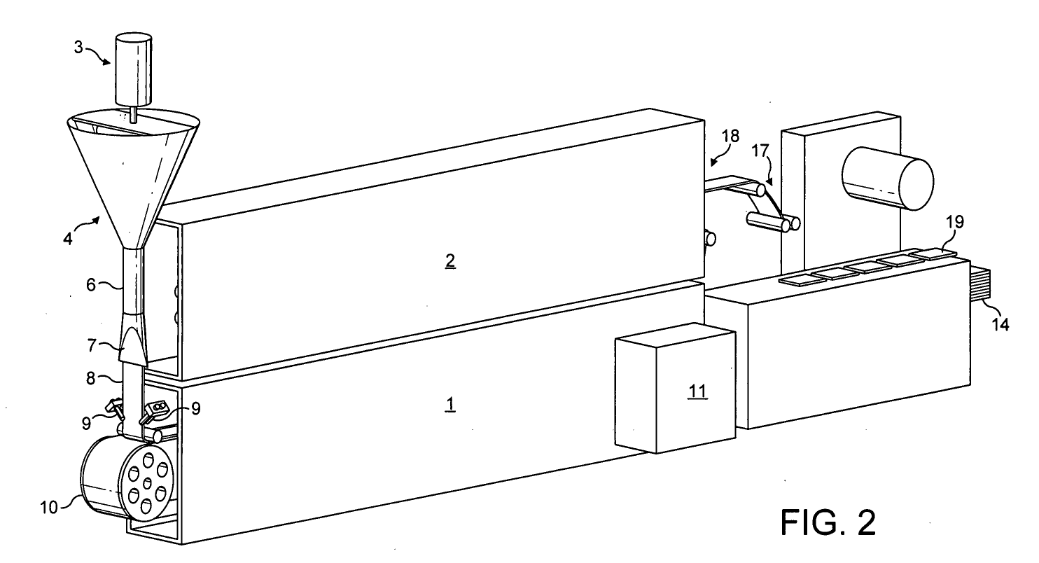

The present invention is further illustrated by way of example only with reference to the explanation below of specific apparatus for the continuous manufacture of Saj bread. This is illustrated in the accompanying drawings in which FIG. 1 is a diagrammatic perspective view of apparatus for carrying out the method of the invention showing internal details, and FIG. 2 similar but showing the casings.

Referring to the drawings, the apparatus consists basically of a central oven 1 and one cooling chamber section 2, dough feed system 3, 4 and an output separation and sizing portion 17. The oven section may be heated by any convenient means, e.g. electrical or a flame burner, e.g. a propane burner.

Referring first to the oven, this consists of a lower elongate oven or chamber 1 and an upper cooling chamber 2, through which a continuous strip of dough passes continuously. The strip of uncooked dough denoted 8 enters the oven chamber 1 and is deposited on to a moving 0.4 mm thick stainless steel conveyor belt which is driven by a conventional drum drive, the driving mechanism being housed in a housing 11. The driving mechanism is preferably a variable speed electric motor and suitable gearing. A drum 10 is shown at the left-hand end of the oven chamber 1 as shown in the drawing, and a driven drum 12 is behind casing 11.

Internally in chamber 2 are a number of rollers and belts which enable the dough to be advanced in sinuous fashion, gradually rising towards the top of the cooling chamber 2 from which it emerges at 18, at the right-hand end of the housing as shown in the drawing. The configuration of the housing chambers 2, including internal baffles and external insulation, may be such as to optimize the time/temperature profile to which the dough is subjected. Means may also be provided to adjust the internal humidity as desired.

The strip of dough is formed by extruding pre-mixed dough through a flat nozzle 7. Upstream of the nozzle is a vertical feed chamber 6 which contains an extruder drive screw driven by an electric motor 3 mounted above a conical hopper 4 into which pre-mixed dough may be placed. When that is done and the motor is energized, the screw extrudes a strip of dough 8 from nozzle 7. Mounted to either side of the emerging strip of dough are two pairs of pinch rollers 9, angled as shown in the drawing. The rollers are freely rotatable and the gap between the rollers is around 1.5 mm. Because of the angling of the roller pairs 9, the edges of the strip are both calendered and biased outwardly from the centre of the strip so that the strip of dough 8, in tolerably relaxed fashion, then turns to lie flat on the steel strip conveyor belt stretched between drums 10 and 11 and extending along the entire length of the oven chamber 1.

When the cooked dough eventually emerges from the upper cooling chamber 2, it passes over a freely rotatable support roller 18 and then between a pair of laterally placed rollers 17, spaced apart corresponding to the width of the desired Saj product. If desired, upstream of rollers 17, cutting discs or the like may be arranged to remove any excess cooked dough. Also associated with rollers 17 is a pair of cutters or shears which are arranged to be intermittently operated so as to cut the now cooked dough strips into a series of rectangular breads 18. These pass over a conveyor table and are stacked at 14.

As shown in the drawing, the stack is of evenly sized rectangular pieces of Saj bread. They may be packed simply and efficiently into plastics covers and sealed to preserve them adequately until they are to be consumed. The plastics cover can, in known fashion, be provided not only with printed material indicating the source, brand or the like, but automatically over-printed with a date of manufacture or a recommended date by which the bread should be consumed. Conventional packing machinery may be used to stack and pack the product, for example a horizontal form, fill and sealing machine such as commercially available under the trade designation AUDION 350T.

1. A method of making a baked dough product which includes the steps of forming a quantity of dough, extruding the dough to form a thin ribbon, passing the ribbon through a heated chamber to cook it, and severing the ribbon into successive rectangular pieces.

2. The method of claim 1 wherein the dough recipe is suitable for the manufacture of Saj bread.

3. Apparatus for carrying out the method of claim 1 and consisting of an elongated heating chamber, means for extruding dough into a thin ribbon and feeding the ribbon into one end of the chamber, conveyor means arranged in the chamber for passing the ribbon of dough through the chamber, and means for severing the ribbon, following its emergence from the chamber, into successive rectangular pieces.

4. The apparatus of claim 3 and including a cooling chamber downstream of the heating chamber and through which the baked dough strip is passed.

5. The apparatus of claim 3 wherein the path of the ribbon through the heating chamber is sinuous.

6. The apparatus of claims 3 and including, between the extrusion means and the entry into the heating chamber, one or more pairs of rollers adapted to engage on opposite sides of the strip of dough and arranged to calender it.

7. The apparatus of claim 6 wherein the calendering is carried out by two pairs of rollers each mounted to one side of the ribbon and where the axes of the rollers do not run perpendicular to the direction of elongation of the ribbon.

8. The apparatus of claim 3 and including UV radiation means to ensure sterility of the emerging cooked dough product.
